(19) United States
(12) Patent Application Publication
(10) Pub. No.: US 2001/0052694 A1
(43) Pub. Date: Dec. 20, 2001

(54) Multifunctional steering wheel

(75) Inventor: Dominik Schutz, Waldaschaff (DE)

Correspondence Address: TAROLLI, SUNDHEIM, COVELL, TUMMINO & SZABO L.L.P., 111 LEADER BLDG., 526 SUPERIOR AVENUE, CLEVELAND, OH, 44114-1400, US

(73) Assignee: TRW Automotive Safety systems GmbH & Co. KG

(21) Appl. No.: 09/877,972

(22) Filed: Jun. 8, 2001

(30) Foreign Application Priority Data
Jun. 14, 2000 (DE) 200 10 543.4

(51) Int. Cl. B60R 21/16; H01H 9/00

(52) U.S. Cl. 280/731; 200/61.54

(57) ABSTRACT

The invention relates to a multifunctional steering wheel comprising a steering wheel skeleton and at least one switch group consisting of remote control switches which are arranged on a circuit board. The steering wheel further comprises a gas bag module, a horn contact switch and a covering for said gas bag module. The horn contact switch is integrated in the circuit board of the switch group.

### TECHNICAL FIELD

The invention relates to a multifunctional steering wheel.

### BACKGROUND OF THE INVENTION

In known steering wheels, the horn contact switch is usually arranged on a separate circuit board between the covering and gas bag module or between the gas bag module and the steering wheel skeleton. In the latter arrangement the gas bag module, in addition, has to be moved relative to the steering wheel skeleton to actuate the horn contact switch. The horn contact switch or the circuit board on which it is arranged therefore has to be handled and fastened individually in the production of the multifunctional steering wheel. In addition, it is necessary for the horn contact switch to have its own connection line which in moving switches also has to be flexible. This represents a considerable expenditure in terms of manufacture and installation.

### BRIEF SUMMARY OF THE INVENTION

The invention therefore aims to provide a multifunctional steering wheel which can be produced and joined together with little expenditure.

This is achieved in a multifunctional steering wheel which comprises a steering wheel skeleton and at least one switch group consisting of remote control switches which are arranged on a circuit board. The steering wheel further comprises a gas bag module, a horn contact switch and a covering for said gas bag module. The horn contact switch is integrated in the circuit board of the switch group. In this way, on assembling the steering wheel, no additional assembly unit for the horn contact switch is to be handled or installed. The production of the switch group and of the horn contact switch can take place in one operating step and advantageously at a supplier specifically equipped for this. Furthermore, the additional connection lines to the horn contact switch are eliminated in this way.

Advantageous developments of the invention and the advantages thereof will be apparent from the sub-claims.

### BRIEF DESCRIPTION OF THE DRAWINGS

FIG. 1 shows a view of a multifunctional steering wheel according to the invention;

FIG. 2 shows a section through the detail II in FIG. 1 in a plane parallel to the plane of observation; and

FIG. 3 shows a diagrammatic view, partially cut, of the detail II from FIG. 1.

### DETAILED DESCRIPTION OF THE PREFERRED EMBODIMENT

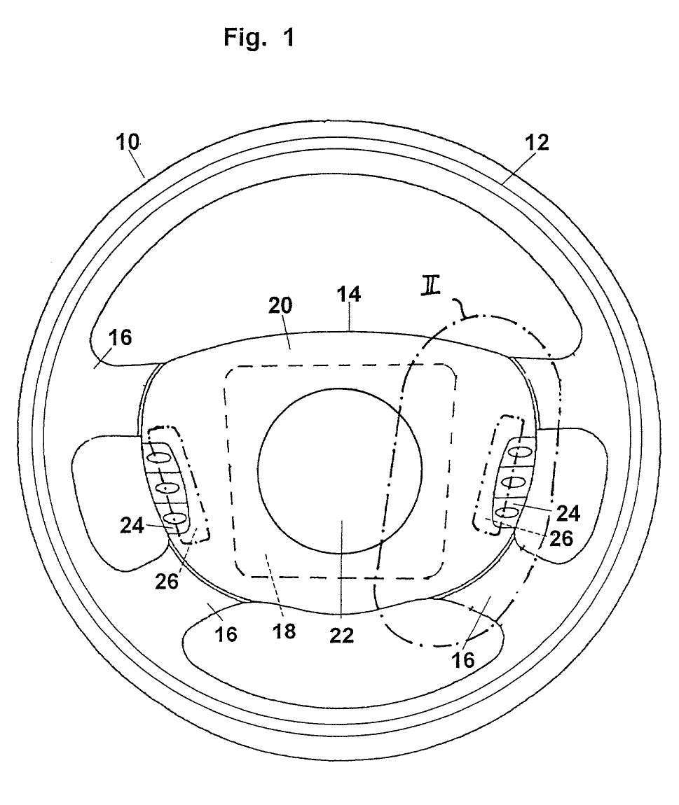

The multifunctional steering wheel 10 illustrated in FIG. 1 has a steering wheel skeleton encased in foam and consisting of a steering wheel rim 12, a steering wheel hub 14 and spokes 16. In the region of the hub 14 the steering wheel 10 is provided with a covering 20. On the hub 14 a gas bag module 18 is arranged which is covered in FIG. 1 by the covering 20 and is therefore indicated by dotted lines. On the surface of the covering 20 pointing towards the vehicle occupant there is a plaque 22 which can be provided with an emblem of the vehicle manufacturer. In the right and left marginal region of the covering (assuming the position of the steering wheel for travelling straight ahead), between the spokes 16, operating elements 24 are provided by means of which remote control switches of a switch group 26, arranged therebeneath in each case, can be actuated for various functions. The operating elements 24 may, for example, be constructed as elastic material sections formed in the covering 20, as clipped-in or molded-on pivoting covering caps or in a different form known to a person skilled in the art.

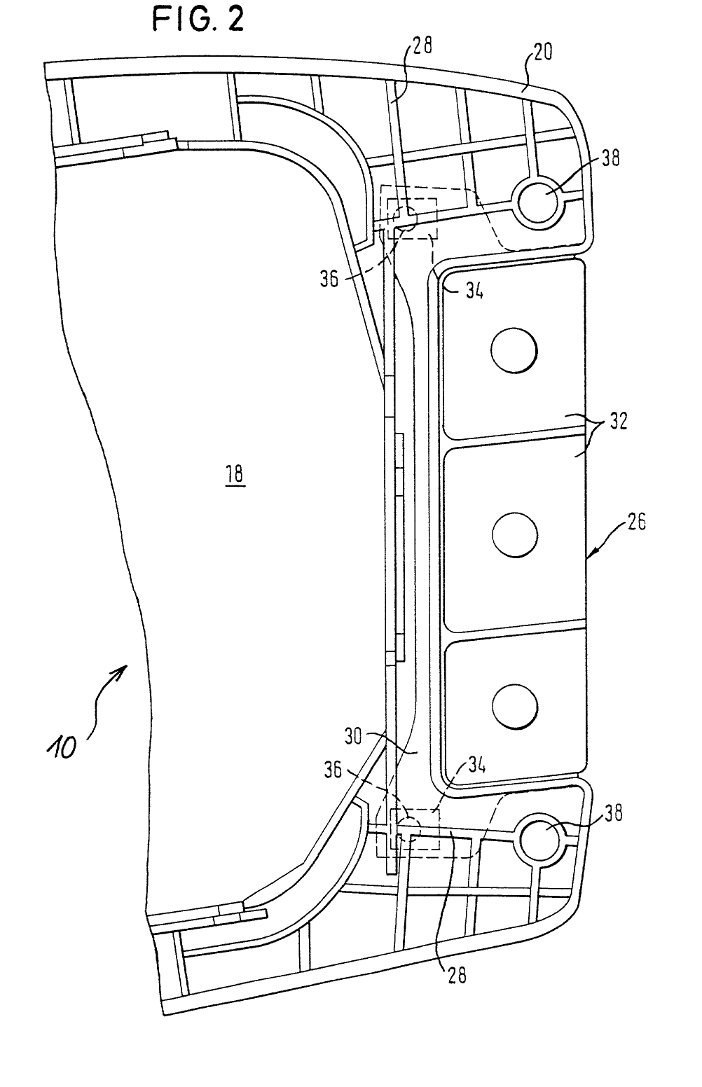

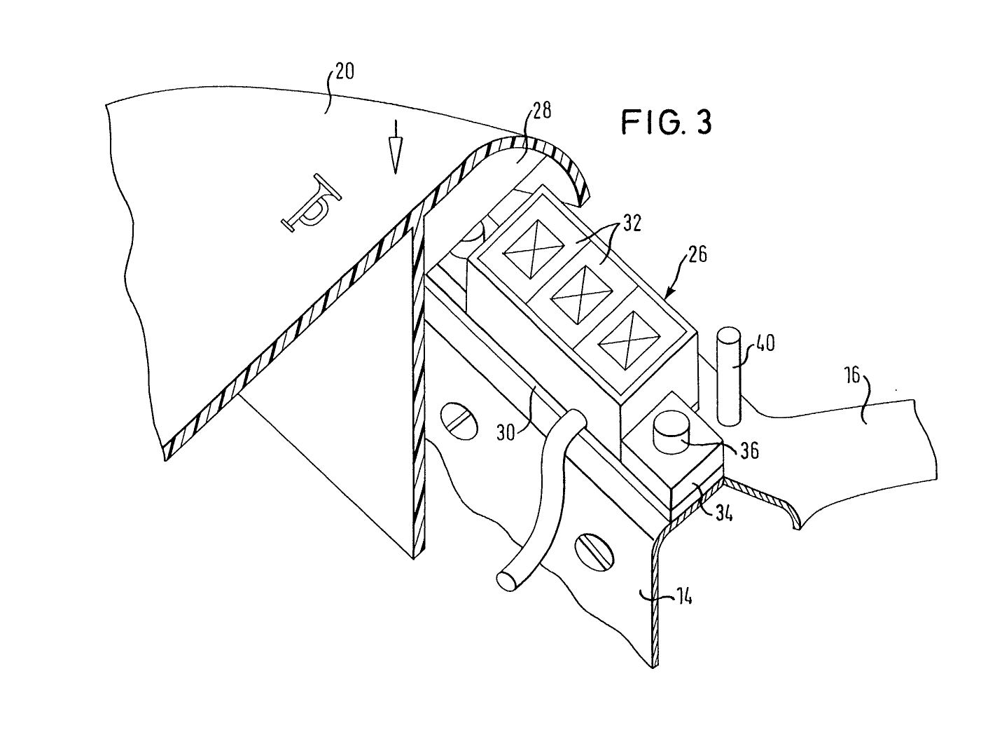

In FIG. 2 there is shown a section through the covering 20, running along a plane parallel to the plane of observation of FIG. 1, the viewing direction being the same as in FIG. 1. In FIG. 3 it can be seen that the covering 20 has ribs 28 on the underside, which serve to stiffen the covering 20. In the illustration, the operating elements 24 are omitted in order to partially expose the view onto a switch group 26. The switch group 26 consists of a circuit board 30 on which remote control switches 32 are arranged. The remote control switches serve for the remote operation of various functions in the vehicle such as, for example, the radio or navigation system, and are actuated by means of the operating elements 24. In addition, horn contact switches 34 in the form of micro-switches are arranged on the circuit board. The remote control switches 32 and the horn contact switches 34 are advantageously arranged on the same side of the circuit board, whereby the circuit board 30 can be easily equipped and soldered in one operating step, so that the manufacture of the switch group 28 is simplified. Of course, other fastening possibilities apart from soldering are also conceivable for fastening the switches.

On each of the two circuit boards of the two switch groups 26 in the described embodiment two horn contact switches 34 each are present. In addition, no further circuit board for remote control switches is provided.

As can be seen in FIG. 2, the horn contact switches 34 are arranged such that their working point 36 in each case lies beneath one of the reinforcement ribs 28. To actuate the horn contact switches 34, pressure is exerted manually onto the surface of the covering 20, whereupon the covering 20 yields and actuates one of the horn contact switches 34 with one of the ribs 28. The resilience of the covering 20 can be achieved in two ways: either by a mounting of the entire covering 20, for instance by springs, so that the covering is displaceable parallel to the rotation axis of the steering wheel 10 in relation to the steering wheel skeleton. A second possibility consists in that the covering 20 can be elastically flexible. Through the manual pressure onto the surface of the covering 20, it is then achieved that the covering deflects and actuates one of the horn contact switches 34 with one of its ribs 28. In this case, the covering does not have to be mounted so as to be displaceable; it may be fixed on the steering wheel skeleton or on the gas bag module. This in turn facilitates the production and the installation of the steering wheel.

In the vicinity of the short sides of the switch group 26, the ribs 28 form cylindrical sleeves 38. As can be seen in FIG. 3, cylindrical studs 40 are provided on the steering wheel hub 14. These studs 40 engage into the openings of the sleeves 38, whereby the sleeves 38 and the pins 40 form guides which establish the position of the covering 20 relative to the steering wheel skeleton. Preferably the guides 38, 40 are situated in the vicinity of the horn contact switches 34. Thereby it is achieved that the positions of ribs 28 and pressure point 36 of the horn contact switches are precisely defined relative to each other. Otherwise, the danger would exist that the rib 28 misses the pressure point 36 as a result of tolerances which are too great in the manufacture and installation of the components or by the bending of the covering.

The use of microswitches with a short switch stroke ensures a reliable switching with a fixed covering, even if the fastening point of the covering lies in the vicinity of the switch and the deflection of the covering therefore only presents a small travel for actuation. This is particularly advantageous if the guide 38, 40 serves at the same time for fastening the covering.

In the embodiment described, the switch group 26 is fastened to the steering wheel hub 14. Of course, this embodiment is only by way of example; the switch group can be fastened just as well on the gas bag module 18. In this case the covering can be readily preassembled as an assembly unit including the gas bag module and the switch group. This assembly unit can be arranged on the steering wheel with little expenditure; in particular, only one electrical connection has to be produced.

As a further design possibility, the covering and the gas bag module can be mounted displaceably as a common unit, so that the horn contact switch is actuated by displacement of this unit. Also in this case, guides in the vicinity of the horn contact switches ensure a reliable actuation.

The invention offers considerable cost advantages in production and installation compared with the multifunctional steering wheels of conventional construction, because the entire electronics can be combined in one component group. This permits external manufacture at a specialized supplier, independently of the gas bag module. Thereby, the functionally separate assemblies of steering wheel, electronics and gas bag module can be produced separately and checked before being assembled.

In contrast to solutions in which the horn contact switches are moved on horn actuation together with the gas bag module or the covering, in the present invention no flexible electrical connection to the horn contact switches is necessary. This in turn increases the reliability of the multifunctional steering wheel.

1. A multifunctional steering wheel, comprising
a steering wheel skeleton,
at least one switch group consisting of remote control switches which are arranged on a circuit board,
a gas bag module,
a horn contact switch and
a covering for said gas bag module,
said horn contact switch being integrated in said circuit board of said switch group.

2. The multifunctional steering wheel according to claim 1, wherein said horn contact switch can be actuated by pressing onto said covering.

3. The multifunctional steering wheel according to claim 1, wherein said switch group is provided on said steering wheel skeleton.

4. The multifunctional steering wheel according to claim 1, wherein said switch group is provided on said gas bag module.

5. The multifunctional steering wheel according to claim 1, wherein said covering is elastically deformable by pressing, and said horn contact is actuated as a result of this elastic deformation.

6. The multifunctional steering wheel according to claim 1, wherein said remote control switches and said horn contact switch are arranged on the same side of said circuit board.

7. The multifunctional steering wheel according to claim 1, wherein said switch group has an elongated shape and wherein guides are provided for one of said modules and said covering, said guides being arranged on short sides of said switch group.

8. The multifunctional steering wheel according to claim 7, wherein said guides adjoin said switch group.
